(19) United States
(12) Patent Application Publication
(10) Pub. No.: US 2006/0214770 A1
(43) Pub. Date: Sep. 28, 2006

(54) Container for delivered items and methods for item delivery

(75) Inventors: John N. Capouch, Eden Prairie, MN (US); James H. Beardsley, Excelsior, MN (US); James M. Nehl, Eden Prairie, MN (US)

Correspondence Address: Brooks & Cameron, PLLC, Suite 500, 1221 Nicollet Avenue, Minneapolis, MN, 55403, US

(73) Assignee: Identity Protection, Inc.

(21) Appl. No.: 11/088,594

(22) Filed: Mar. 24, 2005

(51) Int. Cl. H04Q 1/00; G05B 19/00

(52) U.S. Cl. 340/5.73; 340/5.64

(57) ABSTRACT

Devices, systems, and methods are provided involving the containers for the delivery of items. One embodiment includes a container for delivery of items. This exemplary embodiment includes an enclosure for the placement of a delivered item, a door for providing access to the enclosure, a locking mechanism to restrict the opening of the door to authorized individuals, and a logic component connected to the locking mechanism to control the actuation of the locking mechanism. The logic component includes logic to identify a code provided in a wireless signal to determine when to open the door.

### BACKGROUND

Most individuals and businesses take delivery of items from a variety of delivery carriers from time to time. In receiving these items, the recipient may not be available to receive the items. In such instances, it has become commonplace to have the delivery carrier place the item to be delivered into a container, such as a mailbox or other containment structure, where it can be picked up by the recipient at a later time.

Although convenient, these containers often are unsecured and, therefore, the item, or personal information therein or thereon, can be accessed by individuals other than the intended recipient. Many security concepts have been proposed in attempting to provide better security to the delivered items.

One concept is a lock on the container that can be unlocked by the carrier in order to place the item in the container. However, this concept presumes that the carrier has access to the key to unlock the container. In such containment systems, either the key is accessible somewhere proximate to the container, thereby making it potentially accessible to thieves, or the carrier carries the key, which, if there are many containers with such locks on the carrier's route, makes the system burdensome to the carrier.

Another solution has been to allow an opening for the placement of items into the container, but to have a key to open a door to allow access to the items for their removal. However, such systems do not allow for use of the container for items to be picked up by the carrier, thereby limiting the functionality of the container.

As such, these security concepts have typically been ineffective or impractical due to the competing concerns regarding the level of security provided, the access to the items by the recipient, and the access to the container by the carrier.

### BRIEF DESCRIPTION OF THE DRAWINGS

FIG. 1 is an embodiment of an authorized item delivery system.

FIG. 2 illustrates an embodiment of a container access control mechanism.

FIG. 3 illustrates an embodiment of a remote device for providing an authorization code to a container access controller.

FIG. 4 illustrates a number of components associated with the container access controller.

### DETAILED DESCRIPTION

Embodiments of the present invention provide methods for the containment of delivered items and containers for securing delivered items. In various device embodiments, for example, an embodiment can include an enclosure for the placement of a delivered item. The enclosure includes a door for providing access to the enclosure and a locking mechanism to restrict the opening of the door to authorized individuals.

The access to the enclosure is controlled by a logic component that is connected to the locking mechanism to control the actuation of the locking mechanism. In order to determine who is an authorized individual, the logic component can include logic to identify a code provided in a wireless signal to determine when to open the door. A remote device can be used to provide such an authentication code.

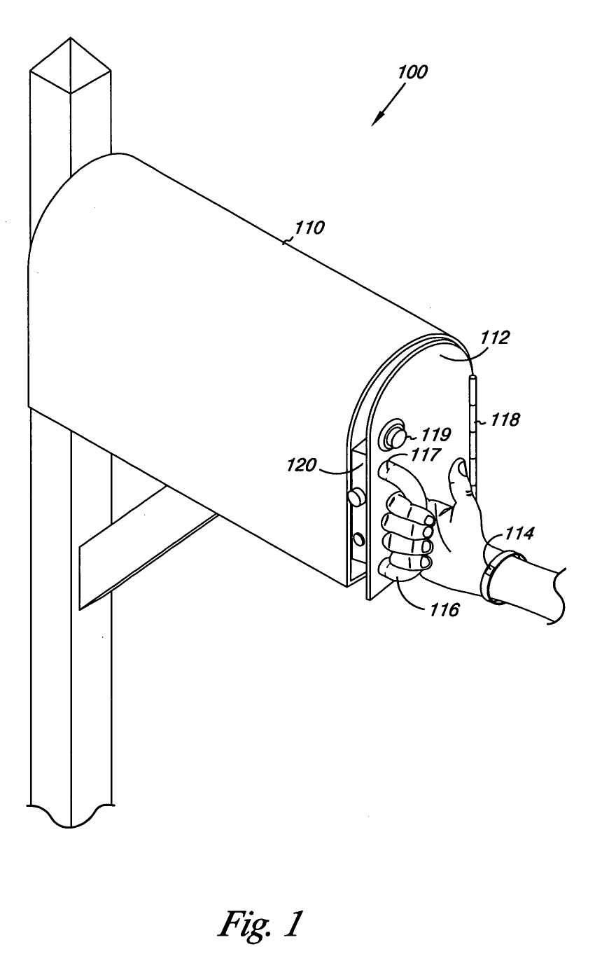

For example, FIG. 1 illustrates an embodiment of an authorized item delivery system. The delivery system 100 of FIG. 1 includes a container 110, in this case, shaped like a standard mailbox, however, the embodiments of the present invention are not so limited.

The container has a door 112 attached to the container 110 by a hinge 118 which allows the door to swing open to provide access to the enclosure formed by the interior walls of the container 110. In some embodiments, the door may be fully removable from the container and, therefore, a hinge may not be present in such embodiments.

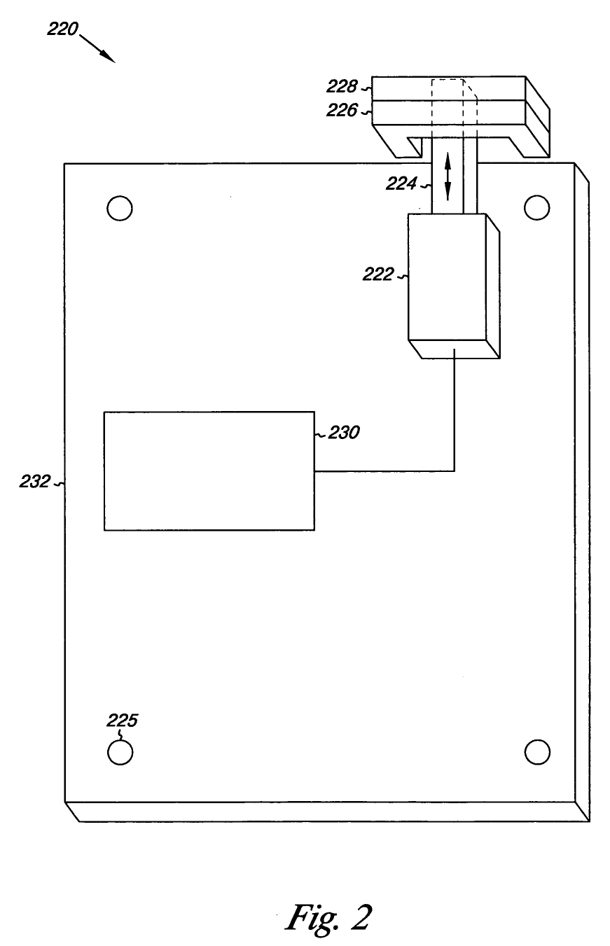

In the embodiment illustrated in FIG. 1, the container 110 also includes a container access control mechanism with a locking mechanism having an open and closed state. The container access control mechanism acts to keep the door locked, thereby restricting access to the enclosure of the container 110. The functionality of the container access control mechanism will be discussed in more detail below with respect to the container access control mechanism 220 illustrated in FIG. 2.

The container 110 of the embodiment of FIG. 1 also includes a handle 116. The handle allows an individual to grasp the handle in order to more easily open the door 112. In some embodiments, such as that shown in FIG. 1, the handle may be a breakaway handle in which the handle will detach from the door 112, when a force is applied to the handle 116 that is greater than a threshold force for detachment of the handle 116.

In some embodiments, for example, the threshold for detachment of the handle 116 can be less than the threshold for overcoming the locking mechanism of the container access control mechanism 120. In this way, if an unauthorized individual attempts to gain access to the container 110 by pulling with extreme force on the handle in hopes of breaking the locking mechanism of the container access control mechanism 120 in such a way that access to the container 110 can be gained, the handle 116 will detach before the threshold for damaging the container access control mechanism is reached. This reduces the ability of the individual to continue to use the handle for leverage against the locking mechanism 120, thereby potentially reducing damage to the container access control mechanism 120, the door 112, and/or the hinge 118.

Although a point of detachment 117 is shown in FIG. 1, the detachment can be designed to occur in various manners and can occur at various places along the handle. In some embodiments, the detachment points can be flush with the surface of the door 112. In this way, once the handle is detached, there is no handle stub that could potentially still be used by an unauthorized individual.

Additionally, the handles can be designed to be easily replaceable such that when a handle becomes detached, a replacement handle can be attached by access to the backside of the door 112. In this way, unauthorized users cannot install a replacement handle unless they have access to the enclosure within the container 110 (which includes the back side of the door 112).

The embodiment of FIG. 1 also includes a remote device 114. The remote device 114 can be used to provide an authorization code to the container access control mechanism 120. Through use of a remote device having an authorization code, an authorized user can gain access to the enclosure within the container 110 in order to pickup items therein or to place items therein.

Remote devices can come in any suitable form. For example, the remote device can be a fob (e.g., key fob), a tag (e.g., plastic or paper type tags), an access card (e.g., a credit card form factor or other card shape), wearable item (e.g., necklace, bracelet, wristwatch, pin, etc), or other suitable form factor.

In some embodiments, for example, a remote device may be in the form of an automobile accessory. In such embodiments, the accessory can then be kept in a delivery vehicle having a particular route and can potentially access the container if positioned close enough to the container to exchange the authorization code information.

An advantage of some of these types of devices, such as a wearable item or automobile accessory, for example, can be that its use can be designed such that it does not affect the functions of the user. For example, a remote device can be designed to be worn by the carrier and the operation of the authorization process will be transparent to the carrier.

In these embodiments, the carrier grasps the handle of the container and opens it, for example, as the carrier typically does when opening a container without the security system implemented thereon. In such an embodiment, the authorization and unlocking of the locking mechanism have been done without the carrier being aware that anything has been done.

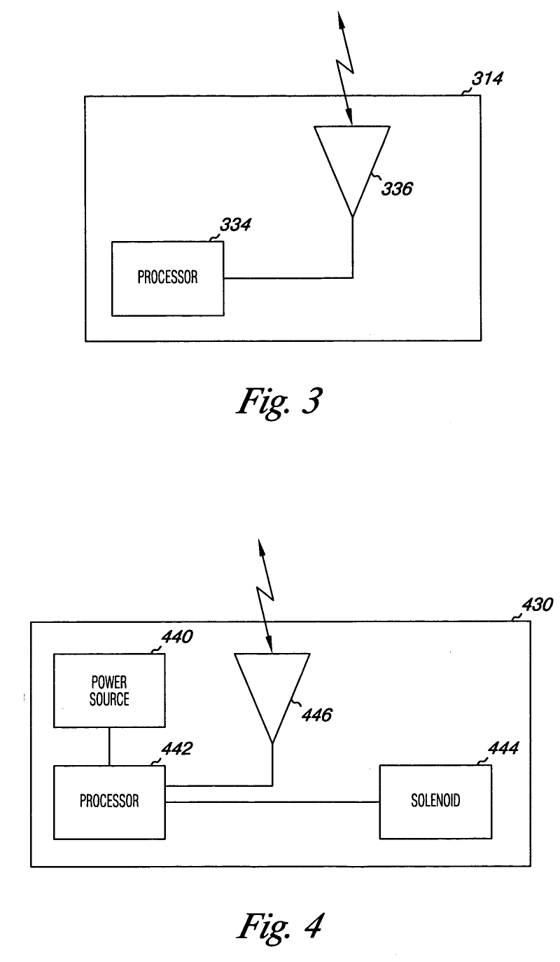

The functionality of a remote device embodiment will be discussed in more detail below with respect to remote device 314 illustrated in FIG. 3.

In various embodiments, such as that shown in FIG. 1, the container access control mechanism 120 can have more than one power mode. For example, a container access control mechanism 120 can utilize a sleep mode where the container access control mechanism draws little or no power. Such embodiments, can be useful for the conservation of energy, longer energy source life, and the like.

In such embodiments, in order to awaken the container access control mechanism 120, a trigger can be provided to bring the container access control mechanism 120 into wake mode. In wake mode, the container access control mechanism can be used to identify if an authorization code is valid, actuate the locking mechanism to lock or unlock the container 110, and other functions associated with operation of the system 100.

In the embodiment shown in FIG. 1, the trigger mechanism is a button 119 actuated by an individual attempting to gain access to the container 110. The trigger mechanism can be any suitable physical or non-physical trigger.

For example, the trigger can be built into the handle 116 such the pressure on the handle or movement of the handle 116 acts as the trigger. Pressure or movement of the door 112 can also act as a physical trigger. With regard to non-physical triggers, in some embodiments, the presence of an energy field, such as an electronic or magnetic field can act as the trigger, for example.

FIG. 2 illustrates an embodiment of a container access control mechanism. In the embodiment illustrated in FIG. 2, the container access control mechanism 220 includes a solenoid 222, a locking bolt 224, a guide block 226, a receiver block 228, and a number of electronic components 230, mounted to a backing plate 232.

Various types of solenoids can be used depending up the features and desired design of the device or system. For example, in FIG. 2, a double latching solenoid is utilized. The double latching solenoid can latch the locking bolt 224 in the open and closed positions. This can be accomplished such that no power is provided to the solenoid once the open or closed position is attained. In this way, power consumption can be reduced. For reference, the locking bolt 224 shown in FIG. 2 is positioned in the closed position (i.e., locked position).

In the open position, the locking bolt will retract such that its end does not extend under the receiver block 228, thereby allowing the door to open. In this way, the double solenoid can keep the lock bolt in the open position which can be beneficial, for example, in embodiments where the locking bolt 224 is positioned in the open position when the power source reaches a threshold level.

In such embodiments, once the threshold level is reached, the locking bolt 224 can be kept in the open position until the level of power at the power source can be raised above the threshold level. The functionality of the power source will be described in more detail below with respect to power source 440 of FIG. 4.

In some embodiments, a guide block can be used (e.g., guide block 226 of FIG. 2). The guide block 226 can be used to guide the positioning of the lock bolt 224 as it articulates between open and closed positions. Further, the guide block can be positioned over the lock bolt 224. In such embodiments, the guide block can be mounted to the door (e.g., door 112 of FIG. 1) to provide extra support to the lock bolt 224 from forces, such as an individual pulling on the handle of the device (e.g., handle 116).

As shown in the embodiment illustrated in FIG. 2, embodiments can also utilize a receiver block 228. The receiver block 228 can be mounted to a side of the container (e.g., container 110) to restrict the movement of the locking bolt 224 when an individual is attempting to open the door of the container.

The receiver block 228 works with the locking bolt 224 to keep the door closed, effectively locking the container when the locking bolt 224 is in the closed position. When the locking bolt 224 is in the open position, the locking bolt 224 passes under the receiving block 228, allowing the door to be opened and, thereby, allowing access to the enclosure of the container.

A variety of electronic components 230 can be provided with the container access control mechanism. For example, the container access control mechanism can include a power source, an antenna, and a logic component (e.g., an application specific integrated circuit (ASIC), a processor, or other type of logic structure).

The components of the container access control mechanism 220 can be mounted on a backing plate 232 that can provide additional structural support and resistance to forces attempting to gain unauthorized access to the container. The backing plate can be made of any suitable material. In the embodiment of FIG. 2, a number of mounting holes 225 are provided for mounting the backing plate to the interior surface of the container. In various embodiments, the backing plate is mounted to the interior surface of the door. In some embodiments, the backing plate 232 and the guide block 226 can be connected or formed together.

FIGS. 3 and 4 represent general components of a remote device embodiment and a container access controller embodiment respectively. The disclosure below with respect to FIGS. 3 and 4 also is used to discuss an example of an interaction between a remote device and a container access controller.

FIG. 3 illustrates an embodiment of a remote device for providing an authorization code to a container access controller. As stated above, any remote device suitable for providing an authorization code to the container access controller can be used with the embodiments of the present invention.

The embodiment of the remote device 314 of FIG. 3 is a wireless passive type remote device. Any type of wireless signal can be used with the various embodiments discussed herein. Such passive devices can be used with a wireless signal in a Radio Frequency Identification (RFID) signal format, for example. The signal can be provided in various signal types, such as in a radio frequency, light frequency, or other transmitting medium.

A passive remote device can be designed to use a power source from another device to generate the power used by the remote device. Typically, the power utilized by a passive remote device is attained by positioning at least a portion of the remote device (i.e., at least a conductive portion such as a portion of a conductive loop) in an ambient energy field, such as a magnetic or electric field provided by the container access controller. The field transfers energy into the conductive portion that can be used to power the remote device.

In such embodiments, a capacitor is sometimes used to build up a power supply sufficient to power the components of the remote device. In addition to acting as an antenna, the conductive material used as the antenna, in some embodiments, can be used to attain the energy to power the remote device. Additionally, in some embodiments, the remote device can include its own power source. Such remote devices are typically referred to as active remote devices. Power sources for such devices can be any suitable source to power the components of the remote device.

In the embodiment shown in FIG. 3, the remote device includes a logic component (e.g., processor) 334 and an antenna 336. In various embodiments, the processor can be another type of logic structure, such as those mentioned above, and/or the antenna can be a transceiver or connected to a transmitter/receiver to communicate the authorization code information to the container access controller. The logic component, in the case of FIG. 3, a processor, can be used for receiving and interpreting a query for an authentication code and/or for initiating the transmission of the authentication code.

Memory can also be provided within the processor or separately to store the authorization code information. In some embodiments, the memory can be read-only memory or write once read many (worm) memory, among other memory types. In such embodiments, the remote device can be provided with a unique code and once the code is not being used the remote device can be discarded. In some embodiments, the remote device can be reprogrammed with another unique number.

The authorization code information, for example, can include a carrier or authorized user identifier, an authorization code, among other information. The authorization code information transmitted to the container access controller can be formatted to have any number of suitable bits. Examples of bit lengths include, but are not limited to, 32, 64, 92, and 128, to name a few.

Remote devices can be used by various types of authorized users. For example, an owner or caretaker of a property, a mailroom supervisor, and a delivery carrier are examples of types of users that can have authorization to access the contents of a container.

Additionally, in some embodiments, different types of authorized users can have different remote devices, or device having different authorization codes. For example, an authorized user, such as the owner or user of the container can have an authorization code that allows for access to their particular container.

A delivery carrier can have an authorization code that can allow the carrier to access multiple containers along their route. In this way, the carrier can potentially have one remote device that can allow the carrier to access all of the containers along their route. This can provide a container system where each owner/user of the multiple containers each has a different code, but where the carrier has one code to access all of the containers. This concept will be described in more detail below.

FIG. 4 illustrates a number of components associated with the container access controller. In the embodiment of FIG. 4, the container access controller 430 can include a logic component (e.g., processor 442), a power source 440, a solenoid 444, and an antenna 446. In some embodiments, the logic component 442 can include logic to identify one code and that code is shared by the box owner/user and the carrier.

In various embodiments, the logic component can identify multiple codes and, therefore, embodiments as described above (e.g., owner/user and carrier having different codes) can be utilized. In such embodiments, the logic component can identify one or more authorized user codes and carrier codes. In such embodiments, the container can, therefore, be accessed by a number of users (e.g., members of a household) and a number of carriers (e.g., postal carrier, FedEx carrier, UPS carrier, etc.).

The logic component can be designed to identify what constitutes an authorized user in any suitable manner. For example, in some embodiments, the logic component can identify a code based upon a match between a code value stored in a memory location associated with the container and a code value provided on a remote device. The match can be provided by a correlation between one or more portions of the code values (e.g., three digits of an alphanumeric remote device code can correspond to three digits of the container access controller code. In such embodiments, the digits may not be in the same order within the overall code provided, nor do they have to be in the same order with respect to each other). In this way, if a correlation and/or match does not occur between a designated portion and/or entire code, the individual is not authorized to access the container. In such embodiments, the memory location can be provided within the container access controller, within the container, or accessible by the container access controller.

In some embodiments, the logic component can restrict access by a previously used code when a replacement code has been accepted into the memory location. For example, in instances when a remote device is lost or stolen, the remote device can be replaced and the authorization code that can be accepted to identify a carrier can be changed. In this way, the previously used code will not allow access to the container once a replacement authorization code has been provided. Embodiments can include logic for accepting replacement carrier, owner, and/or other authorized user codes.

In some embodiments, a remote device can be replaced without having to replace a container. For instance, if the container access controller includes memory that can be rewritten with a replacement code, or where several codes can be stored therein, the replacement code can be provided to the container when the replacement remote device communicates with the container (e.g., when a carrier first approaches the container with the replacement remote device). In such embodiments, the logic associated with the container access controller can identify the replacement authorization code and include instructions to authorize access to the container when the replacement code is presented. In some embodiments, the logic can also deny authorization when the code, that has been replaced, is presented. In this way, the old code cannot be used by an unauthorized user to gain access to the container, such as with a stolen remote device or by an attempt to provide a false code, for example.

In some embodiments, once a user has accessed the container, it may be possible to enable the container access controller to accept one or more new and/or replacement codes. These codes can be used to add additional authorized users and/or as replacing codes.

This can be accomplished in any of various ways. For example, the container access controller can be associated with a switch or button which, when activated, allows for the container access controller to accept the new and/or replacement codes. In this way, an unauthorized user cannot change or add codes because they do not have access to the container access controller within the enclosure of the container.

In other embodiments, the placement of a remote device within the enclosure of the container may initiate logic associated with the container access controller, to change and/or add one or more codes. Those of ordinary skill in the art will recognize that there are other methods of signaling the initiation of such logic components to add or change codes and that such methods may be suitable for use with various embodiments of the present invention.

Further, in some embodiments, the container can be accessed by a replacement remote device in a manner that is transparent to the user of the replacement remote device. For example, the replacement remote device can include a reference to the code that is to be replaced.

In such embodiments, the logic associated with the container access controller can use the code to be replaced as an authorization to change the authorization from the current code to the replacement code. This communication and switching from one code to another can be accomplished without the user of the remote device being aware that any change has been made.

In this way, the user does not have to take any action to implement the change. And, the user may not be aware of either code, therefore, the user cannot use or share that information to gain access for an unauthorized purpose.

The embodiment of FIG. 4 also includes a solenoid 444. Embodiments of the container access controller can contain the solenoid 444, or in some embodiments the solenoid can be provided separately (e.g., as in the embodiment of FIG. 2). The solenoid 444 can be used to actuate the locking mechanism as described above with respect to solenoid 222 in FIG. 2.

The embodiment of FIG. 4 also includes an antenna 446. The antenna can be used to amplify a signal from a remote device.

The power source 440 can be any type of suitable power source. Additionally, multiple power supplies can be used in some embodiments. Examples of suitable power sources include battery power, line or AC power, etc. In some embodiments, the logic component can initiate a sleep mode after a period of time has elapsed since a wireless signal has been received. In this way, the system can save energy.

Additionally, in some embodiments, the logic component can initiate a sleep mode after a threshold number of access attempts have been made. This sleep mode can be set to continue for a period of time. In this way, an unauthorized user cannot repeatedly attempt to access the container in order to wear the battery down.

The power source can also have a power threshold as discussed above. In some embodiments, this threshold can be used to initiate an alert that the power supply is running low on power. The threshold can be set, for example, such that there is sufficient power for a week, a month, or other such time period, so that the owner has the opportunity to replace or restore the power supply.

Through the use of a remote device and a container utilizing a container access controller, embodiments can be provided for use by a carrier to access some or all of the containers on a delivery route. Embodiments can also be provided for a bank of containers within a building, such as the mailboxes within an apartment complex. In such instances, each owner has a remote device with a code that authorizes them to access their particular container and a carrier, the apartment supervisor or other authorized users can be provided with a remote device that authorizes them to access one or more of the number of containers on the route or in the bank of containers.

In such embodiments, each of these authorized individuals can have access to the same containers, or, one or more of the authorized individuals can have access to different groups within the total number of containers. In this way, different individuals can have access to different subsets of the total set of containers. In this way, a carrier company could have a master code to access several carrier routes and a number of carrier codes that allow access to containers on each of a number of routes, respectively.

Although specific embodiments have been illustrated and described herein, those of ordinary skill in the art will appreciate that an arrangement calculated to achieve the same techniques can be substituted for the specific embodiments shown. This disclosure is intended to cover adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A container for delivery of items, comprising:
an enclosure for the placement of a delivered item;
a door for providing access to the enclosure;
a locking mechanism to restrict the opening of the door to authorized individuals;
a logic component connected to the locking mechanism to control the actuation of the locking mechanism, wherein the logic component includes logic to identify a code provided in a wireless signal to determine when to open the door.

2. The container of claim 1, wherein the wireless signal is in a Radio Frequency Identification signal format.

3. The container of claim 1, wherein the logic component can identify at least one authorized user code and carrier code.

4. The container of claim 1, wherein the container includes a trigger mechanism for activating the logic component.

5. The container of claim 1, wherein the container includes a breakaway handle attached to the door.

6. The container of claim 1, wherein the locking mechanism has a force threshold and wherein the breakaway handle is designed to detach from the door with a force that is less than the force threshold of the locking mechanism.

7. The container of claim 1, wherein the logic component identifies a code based upon a match between a code value stored in a memory location associated with the container and a code value provided on a remote device.

8. The container of claim 1, wherein the logic component can restrict access by a previously used code when a replacement code has been accepted into the memory location.

9. An authorized item delivery system, comprising:
a remote device including a logic component and an antenna;
a container for delivery of items, comprising:
an enclosure for the placement of a delivered item;
a door for providing access to the enclosure;
a locking mechanism to restrict the opening of the door to authorized individuals;
means for controlling the actuation of the locking mechanism based upon the identification of a code provided in a wireless signal from the remote device to determine when to open the door.

10. The system of claim 9, wherein the remote device is selected from a group of devices including:
an identification card;
a fob;
a tag;
a bracelet;
a necklace;
a wristwatch;
a pin; and
a vehicle accessory.

11. The system of claim 9, wherein the means for controlling the actuation of the locking mechanism includes a processor, memory, and a receiver for receiving the wireless signal from the remote device.

12. The system of claim 11, wherein the means for controlling the actuation of the locking mechanism includes logic to initiate a sleep mode after a period of time has elapsed since a wireless signal has been received.

13. The system of claim 9, wherein the means for controlling the actuation of the locking mechanism include a memory for storing at least an authorized user code and a carrier code.

14. The system of claim 9, wherein the container includes a power source for actuating the locking mechanism and wherein the means for controlling the actuation of the locking mechanism includes logic to set the locking mechanism to an open position when the power source reaches a power threshold.

15. A remote device for providing authorization to access a container, comprising:
an antenna for receiving a query for an access code;
a memory for storing the access code therein;
a logic component for initiating the transmission of the access code via a wireless signal; and
a transmitter for transmitting the wireless signal.

16. The remote device of claim 15, wherein the remote device includes a transceiver that functions as the antenna and transmitter.

17. The remote device of claim 15, wherein the memory is read-only memory.

18. The remote device of claim 15, wherein the remote device is powered by an ambient energy field.

19. A method, comprising:
assigning a remote device authorization code to a remote device that is to be matched by a container access controller; and
setting a protocol in the container access controller to actuate a locking mechanism when at least a portion of the remote device authorization code corresponds to at least a portion of a container access authorization code that is stored within the container access controller.

20. The method of claim 19, wherein assigning a remote device authorization code includes designing the remote device to transmit a wireless signal having the remote device authorization code to the container access controller.

21. The method of claim 19, wherein the method further includes assigning a replacement authorization code to a remote device that is to correspond to at least a portion of the container access controller.

22. The method of claim 19, wherein the method further includes assigning a replacement authorization code to a remote device that is based upon the remote device authorization code.

23. The method of claim 19, wherein assigning a remote device authorization code to a remote device includes assigning a carrier authorization code;
assigning a user authorization code on a second remote device when access to the container access controller is available to a user; and
setting a protocol in the container access controller to actuate a locking mechanism when at least a portion of at least one of the carrier and user authorization codes corresponds to at least a portion of a container access authorization code that is associated with the container access controller.

24. The method of claim 23, wherein assigning a remote device authorization code to a remote device includes assigning a carrier authorization code that can be used with a number of container access controllers; and wherein assigning a user authorization code includes assigning a user authorization code that can be used with a single container access controller.

25. A computer readable medium having a program to cause a device to perform a method, comprising:
initiating a query by a container access controller of a remote device for a remote device authorization code;
receiving the query with the remote device;
wirelessly sending the remote device authorization code from the remote device to the container access controller;
receiving the remote device authorization code with the container access controller;
identifying whether at least a portion of the remote device authorization code corresponds to at least a portion of a container access authorization code associated with the container access controller; and
actuating a locking mechanism when a match between at least a portion of the remote device and container access authorization codes has been identified.

26. The method of claim 25, wherein the method further includes:
identifying whether at least a portion of the remote device authorization code matches at least a portion of a third authorization code associated with the container access controller; and
actuating a locking mechanism when a match between the remote device and third authorization codes has been identified.

27. The method of claim 25, wherein the initiating of a query by a container access controller of a remote device for a remote device authorization code is provided by the waking of the container access controller from a sleeping state based upon an energy field from the container access controller.

28. The method of claim 25, wherein initiating a query by a container access controller of a remote device for a remote device authorization code includes:
waking the container access controller from a sleeping state;
initiating the emission of an energy field to provide power to the remote device; and
initiating the transmission of the remote device authorization code from the remote device to the container access controller.

29. The method of claim 25, wherein the method further includes initiating the emission of a magnetic energy field by the container access controller to provide power to the remote device.

30. The method of claim 25, wherein the method further includes initiating the emission of an electrical energy field by the container access controller to provide power to the remote device.
